(19) United States
(12) Patent Application Publication
(10) Pub. No.: US 2008/0084584 A1
(43) Pub. Date: Apr. 10, 2008

(54) Emphasizing image portions in an image

(75) Inventor: Petteri Kauhanen, Espoo (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/543,464

(22) Filed: Oct. 4, 2006

(51) Int. Cl. G06K 15/02

(52) U.S. Cl. 358/3.27; 358/1.2

(57) ABSTRACT

This invention relates to a method, a computer readable medium and apparatuses in the context of emphasizing image portions in an image. Image data representing an image is received, the image data is processed to identify specific image portions in the image, wherein the specific image portions are one of a plurality of sharp image portions and a plurality of blurred image portions; and a specific presentation mode is assigned to the specific image portions in the image.

### FIELD OF THE INVENTION

This invention relates to a method, apparatuses and a computer-readable medium in the context of emphasizing specific image portions in an image.

### BACKGROUND OF THE INVENTION

Emphasizing specific image portions in an image is for instance desirable in the application field of digital photography, where said specific image portions may for instance be sharp image portions or blurred image portions.

Generally, when using a digital camera with autofocus and zoom optics, there is a high risk of unwanted blurring of the important image areas, i.e. the depth of field may be too small (or too large), or simply, the camera may be focused to the wrong area of the image field. Especially, when shooting objects in close distance, i.e. when the focus is not in infinity, this risk increases. Macro photography is an extreme example of this—when the object distance is only a few dozens centimeters, the depth of field is often only a few centimeters.

When taking a photo with a digital camera, the user has to evaluate the image sharpness instantly from the display of the digital camera, wherein the display acts as a viewfinder. This may become quite difficult, since the camera display—for instance when being integrated into a mobile phone—may be too small to adequately determine whether the image is correctly focused or not. The result often is that an image, which is assumed to be in good focus, later turns out to be partly or totally blurred, when viewed on a larger display, such as for instance a computer screen.

### SUMMARY

One possibility to indicate the area of sharp focus is to display a rectangle, which has a fixed size and is centered around a single image area for which a maximum sharpness has been determined. Such a rectangle, due to its fixed dimensions, also may frame blurred areas that are situated close to the area of maximum sharpness, for instance in macro photography. Such a rectangle, which only indicates the area of maximum sharpness, does furthermore not provide the user with an idea of the actual area of adequate sharpness throughout the entire image. As a result, peripheral areas of a target that is preferred by a user to be in focus easily end up blurry by accident.

It is thus proposed a method, said method comprising receiving image data representing an image; processing said image data to identify specific image portions in said image, wherein said specific image portions are one of a plurality of sharp image portions and a plurality of blurred image portions; and assigning a specific presentation mode to said specific image portions in said image.

Furthermore, a computer-readable medium having a computer program stored thereon is proposed, the computer program comprising instructions operable to cause a processor to receive image data representing an image; instructions operable to cause a processor to process said image data to identify specific image portions in said image, wherein said specific image portions are one of a plurality of sharp image portions and a plurality of blurred image portions; and instructions operable to cause a processor to assign a specific presentation mode to said specific image portions in said image.

Furthermore, an apparatus is proposed, comprising an input interface for receiving image data representing an image; and a processor configured to process said image data to identify specific image portions in said image, wherein said specific image portions are one of a plurality of sharp image portions and a plurality of blurred image portions, and to assign a specific presentation mode to said specific image portions in said image.

Finally, an apparatus is proposed, comprising means for receiving image data representing an image; means for processing said image data to identify specific image portions in said image, wherein said specific image portions are one of a plurality of sharp image portions and a plurality of blurred image portions; and means for assigning said specific presentation mode to said specific image portions in said image.

Therein, said image data may for instance be received from an image sensor, as for instance a Charge Coupled Device (CCD) or Complementary Metal Oxide Semiconductor (CMOS) sensor. Therein, said image data may be analog or digital data, and may be raw or compressed image data.

Said processing of said image data may be performed by a processor that is contained in the same device as said image sensor, e.g. in a digital camera or in a device that is equipped with a digital camera, such as for instance a mobile phone, a personal digital assistant, a portable computer, or a portable multi-media device, or may be contained in a device that is separate from a device that houses said image sensor. For instance, said processor may be contained in a computer for post-processing said image data.

Said image data is processed to identify specific image portions, which are either a plurality of sharp image portions or a plurality of blurred image portions in said image. In particular, said specific image portions may be either all sharp image portions or all blurred image portions in said image. Therein, said sharp image portions may not be understood as image portions that achieve a maximum sharpness in said image, but as image portions with a sharpness above a certain sharpness threshold, which may be below said maximum sharpness. Said sharpness threshold may for instance be related to the perception capability of the human eye and/or the display capabilities of a device on which said image is to be displayed. Said sharpness may for instance be measured in terms of the Modulation Transfer Function (MTF).

If said processing is performed by a processor in a digital camera or in a device that comprises a digital camera, said processing may for instance be performed during focusing to determine image portions that are in focus and image portions that are out of focus. Equally well, said processing may be performed after capturing of an image. Said identifying of said sharp and blurred image portions may for instance be based on phase detection and/or contrast measurement. Therein, said sharp image portions do not necessarily have to be image portions that achieve maximum sharpness. Equally well, image portions with a sharpness above a certain sharpness threshold may be considered as sharp image portions, whereas the remaining image portions are considered as blurred image portions.

A specific presentation mode is assigned to said specific image portions in said image. This does however not inhibit assigning a further presentation mode to the respective other type of image portion, i.e. a first presentation mode may be assigned to said sharp image portions and a second presentation mode may be assigned to said blurred image portions.

Said specific presentation mode affects the way said specific image portion is presented, for instance if said image with said sharp and blurred image portions is displayed on a display. Said specific presentation mode may differ from a normal presentation mode, i.e. from a presentation mode in which said image would normally be presented or in which said non-specific image portions may be presented.

Furthermore, said specific presentation mode may only affect the image area consumed by said specific image portions, i.e. it may not affect or comprise image area consumed by non-specific image portions. In this way, it may be possible—during presentation of said image—to uniquely identify, based on said specific presentation mode, which image portions of said image are specific image portions and which are not.

Depending on the specific presentation mode and the specific image portions, image portions in said image may be understood to be emphasized when said image is presented under consideration of said specific presentation mode. For instance, if said specific image portions are blurred image portions, and if said specific presentation mode is a black-and-white presentation mode, only sharp image portions may be presented in color, whereas the blurred image portions are presented in black-and-white, and thus said sharp image portions may appear emphasized.

Since said specific image portions are a plurality of sharp image portions or a plurality of blurred image portions, and since said specific presentation mode is assigned to said specific image portions, it is possible, when said image is presented under consideration of said specific presentation mode, to get an overview on which image portions of an image are sharp and which are not, which simplifies the focusing process or allows to determine, after capturing of an image, if said image should be taken again or not. In particular, not only the (single) image portion with maximum sharpness, but a plurality of (sharp or blurred) image portions is assigned a specific presentation mode.

In said specific presentation mode, at least one image property of said specific image portions may be modified. This may comprise modifying said at least one image property for all of said specific image portions. Said image property may for instance be color, brightness, sharpness, resolution, density, transparency and visibility. Equally well, further image properties may be modified.

In said specific presentation mode, at least one of color, brightness, sharpness, resolution, density, transparency and visibility of said specific image portions may be modified. For instance, both color and sharpness of said specific image portions may be modified.

According to a first exemplary embodiment of the present invention, in said specific presentation mode, said specific image portions are presented in black-and-white.

According to a second exemplary embodiment of the present invention, in said specific presentation mode, said specific image portions are presented in single-color. This may for instance be achieved by applying a color filter to said specific image portions.

According to a third exemplary embodiment of the present invention, in said specific presentation mode, said specific image portions are faded out to a specific degree.

According to a fourth exemplary embodiment of the present invention, in said specific presentation mode, said specific image portions are blurred.

According to a fifth exemplary embodiment of the present invention, in said specific presentation mode, said specific image portions are marked by at least one frame. Said frame may have any shape, in particular it may not necessarily have to be a rectangular frame. Said frame may for instance be colored. If said specific image portions are non-adjacent, more than one frame may be required to mark said specific image portions.

According to a sixth exemplary embodiment of the present invention, said specific image portions are said blurred image portions. Said specific presentation mode may then for instance be a presentation mode in which said blurred image portions are less prominent, for instance by fading them out and/or by displaying them in black-and-white, so that a user may concentrate on the sharp image portions in an easier way. In particular, it may then be easier to decide if all components of a desired target are sharp or not, since only the sharp components are emphasized.

According to a seventh exemplary embodiment of the present invention, said specific image portions are one of all sharp image portions and all blurred image portions. Thus said specific image portions are either all sharp image portions in said image, or all blurred image portions in said image. When said image is presented under consideration of said specific presentation mode assigned to said specific image portions, a viewer thus gets a further improved (or more complete) overview on which image areas in the image are sharp or blurred.

An eight exemplary embodiment of the present invention further comprises modifying said image data to reflect said specific presentation mode of said specific image portions; and outputting said modified image data. Said modified data then may be particularly suited for exporting to a further unit, for instance a display unit, where it then may be displayed. Therein, said further unit may be comprised in the same device that performs said receiving of image data, said processing of said image data, said assigning of said specific presentation mode to said specific image portions and said modifying of said image data, or in a separate device.

Therein, since said image data has been accordingly modified, said further unit may not need to be aware that said specific image portions are to be displayed in said specific presentation mode. Alternatively, in said modifying, said image data may only be furnished with additional information, for instance indicating which image portions are to be displayed in said specific presentation mode, and, if several specific presentation modes are available, which of these specific presentation modes is to be applied, and then said further unit may have to process said image data accordingly so that said specific presentation mode is considered when displaying said image.

A ninth exemplary embodiment of the present invention may further comprise displaying said image under consideration of said specific presentation mode. Therein, said receiving of image data, said processing of said image data, said assigning of said specific presentation mode to said specific image portions and said displaying of said image may be performed by the same device or module.

Said receiving and processing of said image data, said assigning of said specific presentation mode and said displaying of said image may be performed during focusing of said image. This may for instance allow a user of a digital camera or a device that is equipped with a digital camera to decide if all desired targets are in focus before actually capturing the image.

Alternatively, said receiving and processing of said image data, said assigning of said specific presentation mode and said displaying of said image may be performed after capturing of said image. This may for instance allow a user of a digital camera or a device that is equipped with a digital camera to decide if all desired targets are in focus, so that an anew capturing of the same image is not required.

According to a tenth exemplary embodiment of the present invention, said identifying of said specific image portions is performed in dependence on a sharpness threshold value. Said sharpness threshold value may not correspond to the maximum sharpness value that is achieved in said image. For instance, said sharpness threshold value may be chosen below said maximum sharpness to allow to differentiate between image portions that are adequately (not maximally) sharp and image portions that are blurred. Said sharpness threshold value may for instance be expressed as MTF value.

Therein, said sharpness threshold value may be defined by a user. In this way, said user may adapt the differentiation between sharp image portions and blurred image portions to his own needs.

According to an eleventh exemplary embodiment of the present invention, said processing of said image data to identify said specific image portions comprises dividing said image into a plurality of image portions; determining contrast values for each of said image portions; and considering image portions of said image to be sharp if said contrast values determined for said image portions exceed a sharpness threshold value, and to be blurred otherwise. Said contrast values may for instance be derived from the Modulation Transfer Function (MTF) of said image portions. Then said sharpness threshold value may for instance also be based on the MTF. Said contrast values may for instance be obtained during passive focusing. Alternatively, said specific image portions may be identified based on phase detection during passive focusing.

It should be noted that the above description of the present invention and its exemplary embodiments equally applies to the method, the computer-readable medium and the apparatuses according to the present invention.

Furthermore, it should be noted that all features described above with respect to specific embodiments of the present invention equally apply to the other embodiments as well and are understood to be disclosed also in combination with the features of said other embodiments.

### BRIEF DESCRIPTION OF THE FIGURES

In the figures show:

FIG. 1: a flowchart of an exemplary embodiment of a method for emphasizing specific image portions in an image according to the present invention;

FIG. 2: a block diagram of an exemplary embodiment of an apparatus according to the present invention;

FIG. 3: a block diagram of a further exemplary embodiment of an apparatus according to the present invention;

FIG. 4: a flowchart of an exemplary embodiment of a method for identifying specific image portions in an image according to the present invention;

FIG. 5a: an exemplary image in which image portions are to be emphasized according to the present invention;

FIG. 5b: an example of a representation of the image of FIG. 5a with emphasized image portions according to an embodiment of the present invention;

FIG. 5c: a further example of a representation of the image of FIG. 5a with emphasized image portions according to an embodiment of the present invention;

FIG. 6a: a further exemplary image in which image portions are to be emphasized according to the present invention;

FIG. 6b: an example of a representation of the image of FIG. 6a with emphasized image portions according to an embodiment of the present invention, where the foreground region is in focus;

FIG. 6c: an example of a representation of the image of FIG. 6a with emphasized image portions according to an embodiment of the present invention, where the middle region is in focus; and

FIG. 6d: an example of a representation of the image of FIG. 6a with emphasized image portions according to an embodiment of the present invention, where the background region is in focus.

### DETAILED DESCRIPTION OF THE INVENTION

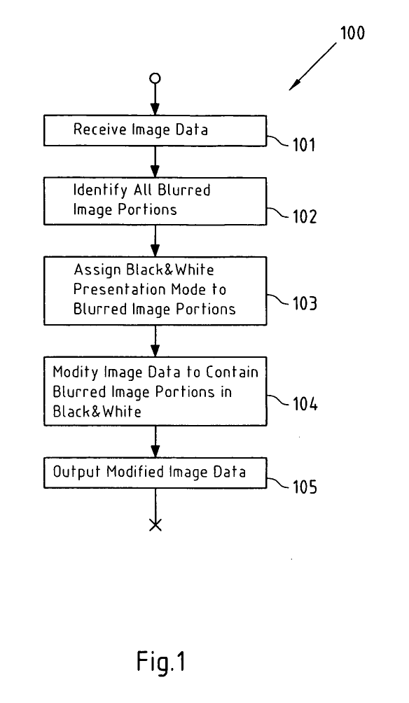

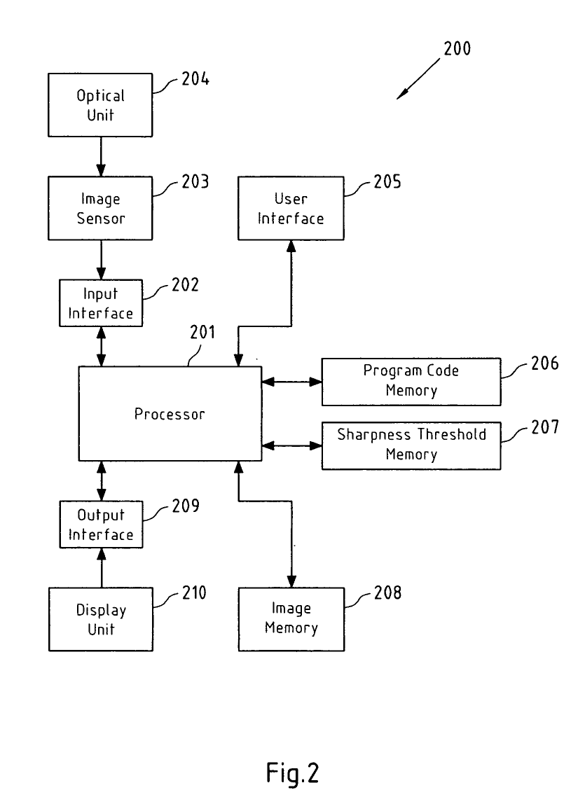

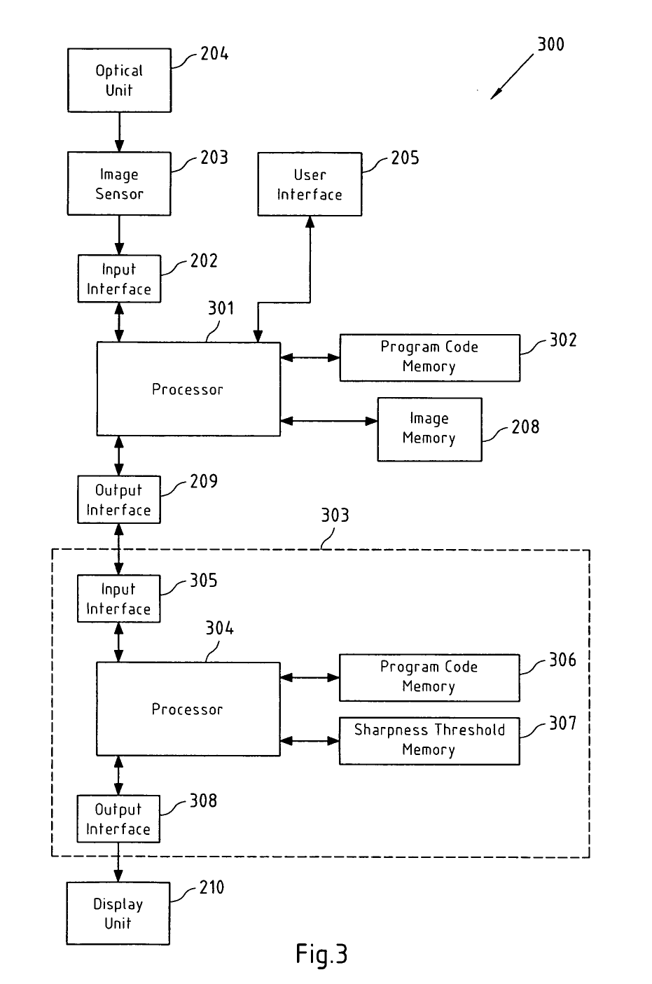

FIG. 1 depicts a flowchart 100 of an exemplary embodiment of a method for emphasizing specific image portions in an image according to the present invention. The steps 101 to 105 of flowchart 100 may for instance be performed by processor 201 (see FIG. 2) or processor 304 (see FIG. 3). In this exemplary example, it is assumed that all blurred image portions in the image are considered as the specific image portions.

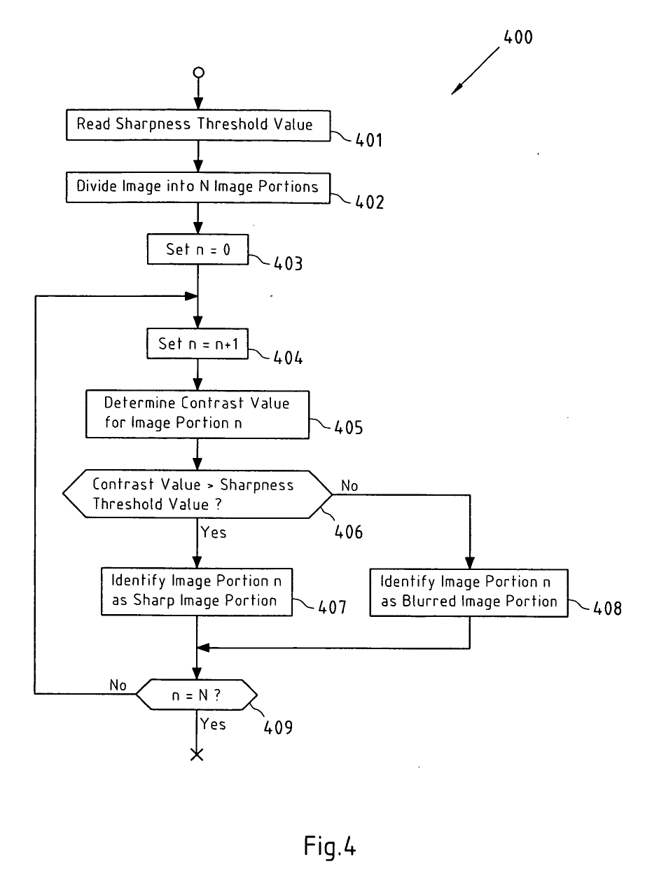

In a first step 101, image data is received, wherein said image data represents an image. In a second step 102, all blurred image portions in said image are identified. Alternatively, also all sharp image portions in said image, or both sharp and blurred image portions could be identified. Said identifying may for instance be performed as described with reference to flowchart 400 in FIG. 4 below. In a step 103, a black-and-white presentation mode is assigned to the identified blurred image portions. In a step 104, the image data is then modified to contain said blurred image portions in black-and-white. In a step 105, the modified image data then is output, so that it may be displayed or further processed.

FIG. 2 shows a block diagram of an exemplary embodiment of an apparatus 200 according to the present invention. Apparatus 200 may for instance be a digital camera, or a device that is equipped with a digital camera, such as for instance a mobile phone. Apparatus 200 comprises a processor 201, which may act as a central processor for controlling the overall operation of apparatus 200. Equally well, processor 201 may be dedicated to operations related to taking, processing and storing of images, for instance in a device that, among other components such as a mobile phone module and an audio player module, is also equipped with a digital camera.

Processor 201 interacts with an input interface 202, via which image data from an image sensor 203 can be received. Image sensor 203, via optical unit 204, is capable of creating image data that represents an image. Image sensor 203 may for instance be embodied as CCD or CMOS sensor. Image data received by processor 201 via input interface 202 may be both analog and digital image data, and may be compressed or uncompressed.

Processor 201 is further configured to interact with an output interface 209 for outputting image data to a display unit 210 for displaying the image that is represented by the image data. Processor 201 is further configured to interact with an image memory 208 for storing images, and with a user interface 205, which may for instance be embodied as one or more buttons (e.g. a trigger of a camera), switches, a keyboard, a touch-screen or similar interaction devices.

Processor 201 is further capable of reading program code from program code memory 206, wherein said program code may for instance contain instructions operable to cause processor 201 to perform the method steps of the flowchart 100 of FIG. 1. Said program code memory 206 may for instance be embodied as Random Access Memory (RAM), or a Read-Only Memory (ROM). Equally well, said program code memory 206 may be embodied as memory that is separable from apparatus 200, such as for instance as a memory card or memory stick. Furthermore, processor 201 is capable of reading a sharpness threshold value from sharpness threshold memory 207.

When a user of apparatus 200 wants to take a picture, he may use user interface 205 to signal to processor 201 that a picture shall be taken. In response, processor 201 then may perform the steps of flowchart 100 of FIG. 1 to emphasize image portions, i.e. receiving image data from image sensor 203 via input interface 202, identifying all blurred image portions in the image that is represented by the image data, assigning a black-and-white presentation mode to the blurred image portions, modifying the image data to contain said blurred image portions in black-and-white, and outputting said modified image data to display unit 210 via output interface 209 (the control of optical unit 204 and image sensor 203, which may be exerted by processor 201, is not discussed here in further detail). Alternatively, said modified image data may be output to an external device for further processing as well.

Therein, to identify all blurred image portions in the image, processor 201 may perform the steps of flowchart 400 of FIG. 4, as will be discussed in further detail below.

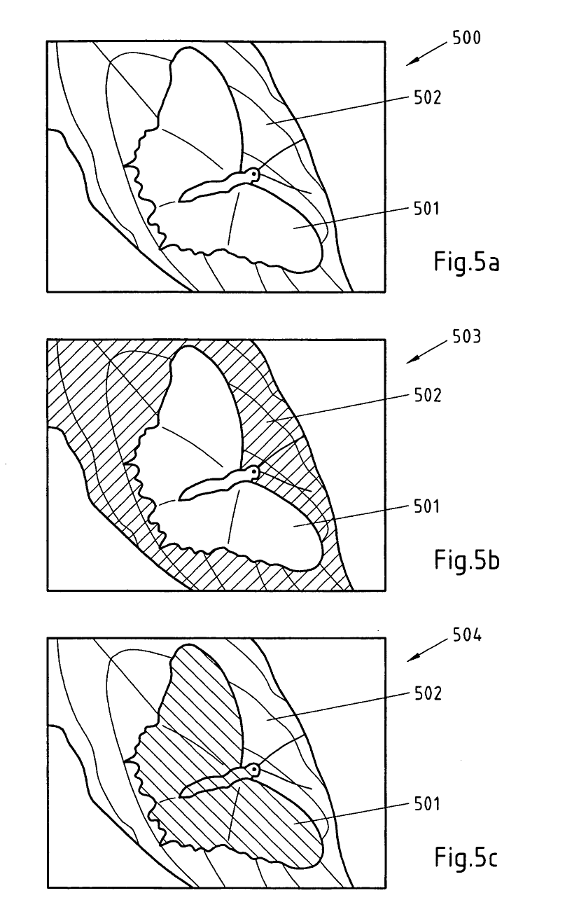

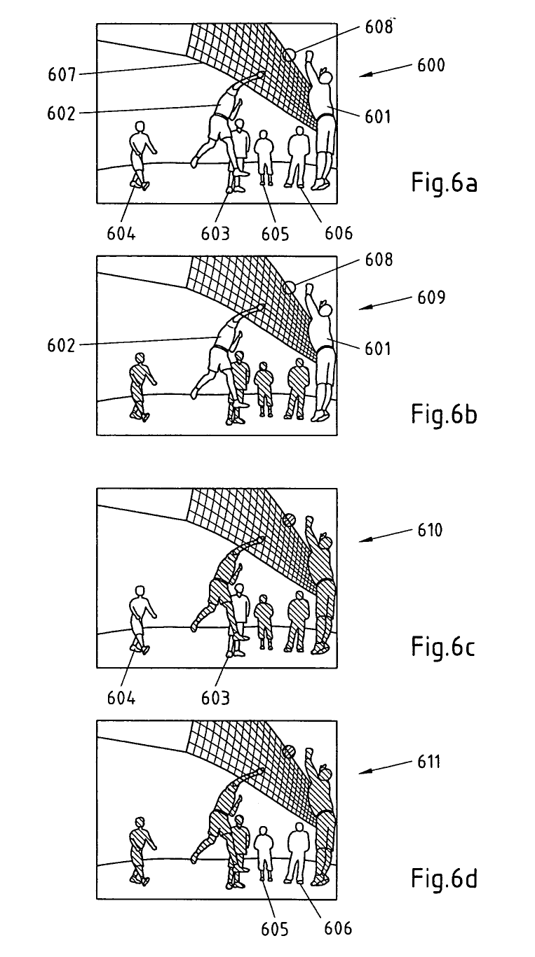

Since display unit 210 receives modified image data, i.e. image data in which all blurred image portions are presented in black-and-white, whereas all sharp image portions are presented in color, it is particularly easy for the user to determine if the objects that are to be photographed are in adequate focus or not. The user simply has to inspect if all desired objects are presented in color or not. Examples for this presentation of image data will be given with respect to FIGS. 5a-5c and 6a-6d below. If the desired targets are not in focus, the user may simply change the camera parameters (lens aperture, zoom, line of vision) and check the result on display unit 210.

So far, it was exemplarily assumed that, when a photograph is to be taken, processor 201 automatically performs the steps of flowchart 100 (see FIG. 1) for emphasizing specific image portions. Alternatively, the steps of flowchart 100 may only be taken upon user request, for instance when the user presses a focusing button (i.e. the trigger of a camera) or performs a similar operation. As a further alternative, processor 201 may only perform steps for emphasizing image portions after an image has been captured. Said image data may then for instance be received from image memory 208. Even then, presenting the blurred image portions in black-and-white is advantageous, since the user then can determine if all desired objects are sharp enough or if the picture should be taken anew.

FIG. 3 shows a block diagram of a further exemplary embodiment of an apparatus 300 according to the present invention. Therein, components of apparatus 300 that correspond to components of apparatus 200 (see FIG. 2) have been assigned the same reference numerals and are not explained any further.

Apparatus 300 differs from apparatus 200 in that apparatus 300 comprises a module 303, which is configured to emphasize image portions in an image. To this end, module 303 is furnished with an own processor 304, input and output interfaces 305 and 308, a program code memory 306 and a sharpness threshold memory 307.

In apparatus 300, when a picture is to be taken, image data is received from processor 301 via input interface 202 from image sensor 203, and would, without the presence of module 303, simply be fed into display unit 210 via output interface 209 for displaying. Therein, processor 301 is not configured to emphasize image portions, its functionality may in particular be limited to controlling the process of taking and storing pictures.

By slicing in module 303 into the path between output interface 209 and display unit 210, it can be achieved that image portions in images that are displayed on display unit 210 are emphasized, possibly without affecting the operation of processor 301 and the overall process of taking and storing pictures.

To this end, processor 304 of module 303 may perform the steps of flowchart 100 of FIG. 1, i.e. to receive image data via input interface 305 from output interface 209, to identify all blurred image portions in the image that is represented by the image data, to assign the black-and-white presentation mode to the blurred image portions, to modify the image data so that the blurred image portions are in black-and-white, and to output the modified image data to display unit 210 via output interface 308.

Therein, to identify all blurred image portions in the image, processor 304 of module 303 may perform the methods steps of flowchart 400 (see FIG. 4).

FIG. 4 depicts a flowchart 400 of an exemplary embodiment of a method for identifying specific image portions in an image according to the present invention. This method may for instance be performed by processor 201 (see FIG. 2) and processor 304 (see FIG. 3). In a first step 401, a sharpness threshold value is read, for instance from sharpness threshold memory 207 of apparatus 200 (see FIG. 2) or sharpness threshold memory 307 of apparatus 300 (see FIG. 3). Said sharpness threshold value may for instance be defined by a user via user interface 205 (FIG. 2) and then written into sharpness threshold memory 207. Alternatively, said sharpness threshold value may be a pre-defined value that is stored in said memory during manufacturing. Said sharpness threshold value may for instance depend on the perception capabilities of the human eye and/or the display capabilities of display unit 210 or another display unit. An example for the sharpness threshold value may for instance be a Modulation Transfer Function (MTF) value of 20%.

In a step 402, the image in which blurred image portions are to be identified is divided into N image portions, for instance into quadratic or rectangular image areas. In a loop, which is controlled by steps 403, 404 and 409, for each of these N image portions, a contrast value, for instance in terms of the MTF, is determined (step 405). If the contrast value is larger than the sharpness threshold value, the corresponding image portion is considered as a sharp image portion (step 407), or otherwise as blurred image portion (step 408). In this way, all sharp and all blurred image portions are identified.

FIG. 5a is an exemplary image 500 in which image portions are exemplarily to be emphasized according to the present invention. Image 500 contains a butterfly 501 residing on a leaf 502. In this macro photography example, butterfly 501 is located in the foreground of image 500, and leaf 502 is located in the background, so that, despite of the comparably small distance between butterfly 501 and leaf 502, one of both easily becomes de-focused and thus blurred.

FIG. 5b depicts an example of a representation 503 of image 500 of FIG. 5a with emphasized image portions according to an embodiment of the present invention. Representation 503 may for instance be displayed on display unit 210 (see FIGS. 2 and 3) when image 500 is to be taken as a picture by apparatus 200 (FIG. 2) or 300 (FIG. 3). In representation 503, leaf 502 is blurred, and it thus assigned a black-and-white presentation mode. In FIG. 5b, this is illustrated by a hatching. In representation 503, thus butterfly 501 appears in color, since it is in focus (sharp), whereas leaf 502 appears in black-and-white, since it is out-of-focus (blurred). In this way, butterfly 501, i.e. the object which is in focus, is emphasized.

FIG. 5c depicts a further example of a representation 504 of image 500 of FIG. 5a with emphasized image portions according to an embodiment of the present invention. Therein, now leaf 502 is in focus, and butterfly 502 is out-of-focus, so that butterfly 501 is presented in a specific presentation mode (a black-and-white presentation mode, illustrated by a hatching).

As a further example, not being directed to macro photography, FIG. 6a shows a further exemplary image 600 in which image portions are to be emphasized according to the present invention. Image 600 contains a scene of a volleyball game, wherein players 601-606, a net 607 and a ball 608 are visible. These components of image 600 are located in different layers and are thus impossible to be in focus at the same time.

FIG. 6b depicts an example of a representation 609 of image 600 of FIG. 6a with emphasized image portions according to an embodiment of the present invention. Therein, players 601 and 602 and ball 608, which are in a foreground layer of image 600, are in focus. This causes all other components of image 600 to be out-of-focus (blurred), and these components thus are assigned a specific (black-and-white) presentation mode. When desiring to focus players 601 and 602 and ball 608, it is thus easy for a user to check the representation 609 to determine if (at least) these components are in color. Otherwise, a new focusing attempt or an additional taking of a picture is required.

FIG. 6c depicts a further representation 610 of image 600 of FIG. 6a, in which players 603 and 604 in a middle layer of image 600 are in focus, so that all other components are presented in black-and-white (as indicated by the hatching of these components).

Finally, FIG. 6d depicts a representation 611 of image 600 of FIG. 6a, in which players 605 and 606 in a background layer of image 600 are in focus, and all other components of image 600 located in layers before are presented in black-and-white (as indicated by the hatching of these components).

It is thus readily clear that checking if a target or group of targets is in focus when focusing or capturing an image is vastly simplified by the above-described embodiments of the present invention.

The invention has been described above by means of exemplary embodiments. It should be noted that there are alternative ways and variations which are obvious to a skilled person in the art and can be implemented without deviating from the scope and spirit of the appended claims. In particular, it is to be understood that, instead of presenting blurred image areas in black-and-white, equally well other presentation modes may be applied, for instance fading out blurred image portions, applying a colored half-transparent mask to blurred image portions, or similar presentation modes. It is also to be understood that, instead or in addition to the specific presentation of blurred image portions, also the sharp image portions could be presented in an alternative specific presentation mode.

What is claimed is:

1. A method, comprising:
receiving image data representing an image;
processing said image data to identify specific image portions in said image, wherein said specific image portions are one of a plurality of sharp image portions and a plurality of blurred image portions; and
assigning a specific presentation mode to said specific image portions.

2. The method according to claim 1, wherein in said specific presentation mode, at least one image property of said specific image portions is modified.

3. The method according to claim 1, wherein in said specific presentation mode, at least one of color, brightness, sharpness, resolution, density, transparency and visibility of said specific image portions is modified.

4. The method according to claim 1, wherein in said specific presentation mode, said specific image portions are presented in black-and-white.

5. The method according to claim 1, wherein in said specific presentation mode, said specific image portions are presented in single-color.

6. The method according to claim 1, wherein in said specific presentation mode, said specific image portions are faded out to a specific degree.

7. The method according to claim 1, wherein in said specific presentation mode, said specific image portions are blurred.

8. The method according to claim 1, wherein in said specific presentation mode, said specific image portions are marked by at least one frame.

9. The method according to claim 1, wherein said specific image portions are said blurred image portions.

10. The method according to claim 1, wherein said specific image portions are one of all sharp image portions and all blurred image portions.

11. The method according to claim 1, further comprising:
modifying said image data to reflect said specific presentation mode of said specific image portions; and
outputting said modified image data.

12. The method according to claim 1, further comprising:
displaying said image under consideration of said specific presentation mode.

13. The method according to claim 12, wherein said receiving and processing of said image data, said assigning of said specific presentation mode and said displaying of said image are performed during focusing of said image.

14. The method according to claim 12, wherein said receiving and processing of said image data, said assigning of said specific presentation mode and said displaying of said image are performed after capturing of said image.

15. The method according to claim 1, wherein said identifying of said specific image portions is performed in dependence on a sharpness threshold value.

16. The method according to claim 15, wherein said sharpness threshold value can be defined by a user.

17. The method according to claim 1, wherein said processing of said image data to identify said specific image portions comprises:
dividing said image into a plurality of image portions;
determining contrast values for each of said image portions; and
considering image portions of said image to be sharp if said contrast values determined for said image portions exceed a sharpness threshold value, and to be blurred otherwise.

18. The method according to claim 1, wherein said method is performed in one of a digital camera and a device that is equipped with a digital camera.

19. The method according to claim 1, wherein said method is performed in a device that is equipped with a digital camera, and wherein said device is one of a mobile phone, a personal digital assistant, a portable computer and a portable multi-media device.

20. A computer-readable medium having a computer program stored thereon, the computer program comprising:
instructions operable to cause a processor to receive image data representing an image;
instructions operable to cause a processor to process said image data to identify specific image portions in said image, wherein said specific image portions are one of a plurality of sharp image portions and a plurality of blurred image portions; and
instructions operable to cause a processor to assign a specific presentation mode to said specific image portions.

21. The computer-readable medium according to claim 20, wherein in said specific presentation mode, at least one image property of said specific image portions is modified.

22. An apparatus, comprising:
an input interface for receiving image data representing an image; and
a processor configured to process said image data to identify specific image portions in said image, wherein said specific image portions are one of a plurality of sharp image portions and a plurality of blurred image portions, and to assign a specific presentation mode to said specific image portions.

23. The apparatus according to claim 22, wherein in said specific presentation mode, at least one image property of said specific image portions is modified.

24. The apparatus according to claim 22, wherein said specific presentation mode is related to at least one of color, brightness, sharpness, resolution, density, transparency and visibility of said specific image portions.

25. The apparatus according to claim 22, wherein said specific image portions are said blurred image portions.

26. The apparatus according to claim 22, wherein said specific image portions are one of all sharp image portions and all blurred image portions.

27. The apparatus according to claim 22, wherein said processor is further configured to modify said image data to reflect said specific presentation mode of said specific image portions; and wherein said apparatus further comprises:
an output interface configured to output said modified image data.

28. The apparatus according to claim 22, further comprising:
a display configured to display said image under consideration of said specific presentation mode.

29. The apparatus according to claim 22, wherein said processor is configured to identify said sharp image portion and said blurred image portion in dependence on a sharpness threshold value.

30. The apparatus according to claim 22, wherein said processor is configured to identify said specific image portions by dividing said image into a plurality of image portions; by determining contrast values for each of said image portions; and by considering image portions of said image to be sharp if said contrast values determined for said image portions exceed a sharpness threshold value, and to be blurred otherwise.

31. The apparatus according to claim 22, wherein said apparatus is one of a digital camera and a device that is equipped with a digital camera.

32. The apparatus according to claim 22, wherein said apparatus is a module for one of a digital camera and a device that is equipped with a digital camera.

33. The apparatus according to claim 22, wherein said apparatus is a device that is equipped with a digital camera, and wherein said device is one of a mobile phone, a personal digital assistant, a portable computer and a portable multi-media device.

34. An apparatus, comprising:
means for receiving image data representing an image;
means for processing said image data to identify specific image portions in said image, wherein said specific image portions are one of a plurality of sharp image portions and a plurality of blurred image portions; and
means for assigning a specific presentation mode to said specific image portions.

35. The apparatus according to claim 34, wherein in said specific presentation mode, at least one image property of said specific image portions is modified.
